(19) United States
(12) Patent Application Publication
(10) Pub. No.: US 2004/0086105 A1
(43) Pub. Date: May 6, 2004

(54) Nighttime automatic illuminating device for telephone

(76) Inventor: Wei-Fu Chang, Maioli (TW)

Correspondence Address: BACON & THOMAS, PLLC, 625 SLATERS LANE, FOURTH FLOOR, ALEXANDRIA, VA, 22314

(21) Appl. No.: 10/424,931

(22) Filed: Apr. 29, 2003

(30) Foreign Application Priority Data
Nov. 5, 2002 (TW) 91217743

(51) Int. Cl. H04M 1/00; H04M 3/00

(52) U.S. Cl. 379/376.01

(57) ABSTRACT

A nighttime automatic illuminating device for telephones comprises a call detection circuit, an illumination detection circuit, an automatic illumination signal circuit, a driving means for automatic illumination light, a trigger pulse generation circuit, a lights-off delay timer circuit and a power source circuit, through which ring signals of telephones and telephones' being in current use or not can be detected. Also, through linking the illumination detection circuit and the call detection circuit, the nighttime automatic illuminating device for telephones can further be enabled to provide with secure and efficient illumination by corresponding to various degrees of illumination from the surrounding environment.

### BACKGROUND OF THE INVENTION

1. Field of the Invention

The present invention relates to a nighttime automatic illuminating device for telephones, whereby during the time when a telephone receives ring signals transmitted via the telecommunication wire with the surrounding of the telephone being dark, the automatic illumination light is activated to provide the user with illumination needed.

2. Description of Related Arts

The conventional telephone illumination device is formed by mounting an illumination light on the telephone body for providing the user with illumination during phone conversation. Even though the illumination light has the identical power source as the telephone, an independent switch is required to turn the illumination light on and off. Therefore when the user needs better illumination during phone conversation, the switch for the illumination light has to be turned on manually so as to acquire the sufficient illumination, thus causing inconvenience to the user.

In view of such inconvenience regarding nighttime telephone usage, an illumination device able to be activated via ring signals or signals showing current usage is provided for improving the foregoing inconvenience. However, such kind of solution does provide enough illumination for the user during telephone usage, but the illumination device can only be activated via ring tones or signals showing current usage. Thus even though the user uses the telephone in a well-lit environment, the illumination device thereof shall still be turned on, causing waste of energy.

### SUMMARY OF THE INVENTION

The primary object of the present invention is to provide a nighttime automatic illumination device for telephones, comprising a call detection circuit, an illumination detection circuit, an automatic illumination signal circuit, a driving means for automatic illumination light, a trigger pulse generation circuit, a lights-off delay timer circuit and a power source circuit, whereby the illumination light can be automatically activated by the automatic illumination device when any incoming ring signals is detected, and the turning off of the illumination light shall be automatically delayed after phone usage.

The nighttime automatic illumination device capable of achieving the foregoing object comprises:

a call detection circuit for detecting any incoming ring signals inputted via the telecommunication wire of a telephone,

an illumination detection circuit for detecting the degree of illumination surrounding the telephone;

an automatic illumination signal circuit for activating a trigger pulse generation circuit;

the trigger pulse generation circuit for activating a driving means for automatic illumination light;

the driving means for automatic illumination light for driving the illumination of the light according to signals transmitted from the trigger pulse generation circuit;

a lights-off delay timer circuit for cutting off power inputted to the trigger pulse generation circuit; and

a power source circuit for providing with power needed by the circuit members.

The signal input end of the automatic illumination signal circuit is connected to the signal output ends of both the call detection circuit and the illumination detection circuit.

The signal output end of the automatic illumination signal circuit is connected to the signal input ends of both the lights-off delay timer circuit and the trigger pulse generation circuit.

The signal output end of the lights-off delay timer circuit is connected to another signal input end of the trigger pulse generation circuit.

The lights-off delay timer circuit further includes a variable resistor for predetermining the cut-off time of the inputting power to the trigger pulse generation circuit.

### BRIEF DESCRIPTION OF THE DRAWINGS

These and other features, aspects and advantages of the present invention will become better understood with regard to the following description, appended claims and accompanying drawings that are provided only for further elaboration without limiting or restricting the present invention, where:

FIG. 1 shows a block diagram of the nighttime automatic illumination device of the present invention;

FIG. 2 shows a circuit diagram of the nighttime automatic illumination device of the present invention; and

FIG. 3 shows a flow chart of the nighttime automatic illumination device of the present invention.

### DETAILED DESCRIPTION OF THE PREFERRED EMBODIMENT

The following is a detailed description of the best presently known modes of carrying out the inventions. This description is not to be taken in a limiting sense, but is made merely for the purpose of illustrating the general principles of the inventions.

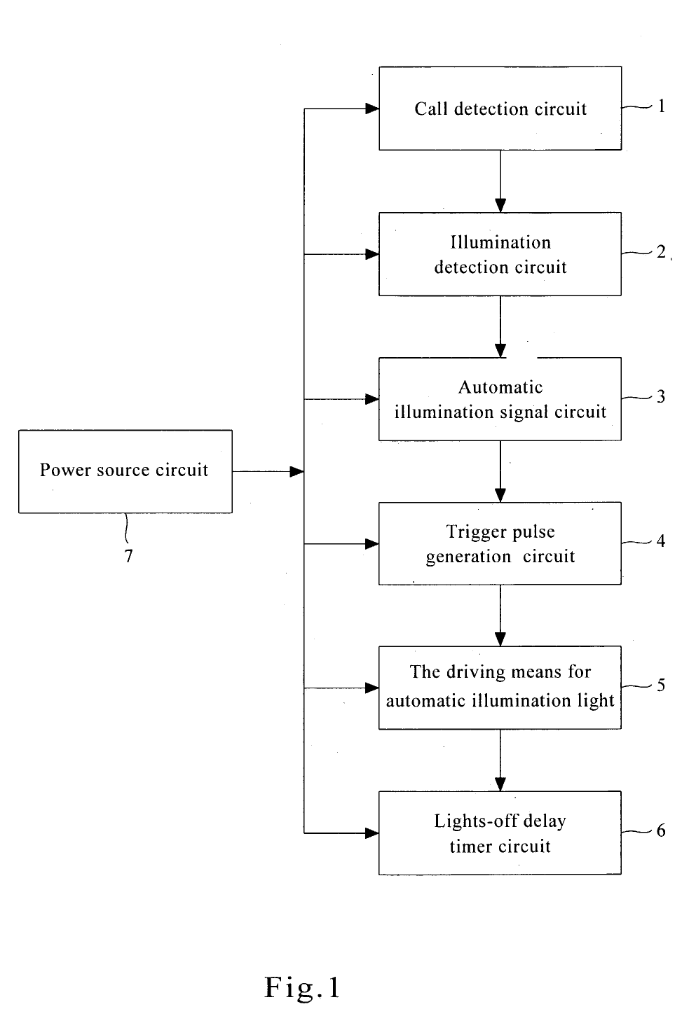

Please refer to FIG. 1, which shows a block diagram of the nighttime automatic illumination device of the present invention, the automatic illumination device of the present invention comprises a call detection circuit 1, an illumination detection circuit 2, an automatic illumination signal circuit 3, a trigger pulse generation circuit 4, a driving means for automatic illumination light 5, a lights-off delay timer circuit 6 and a power source circuit 7.

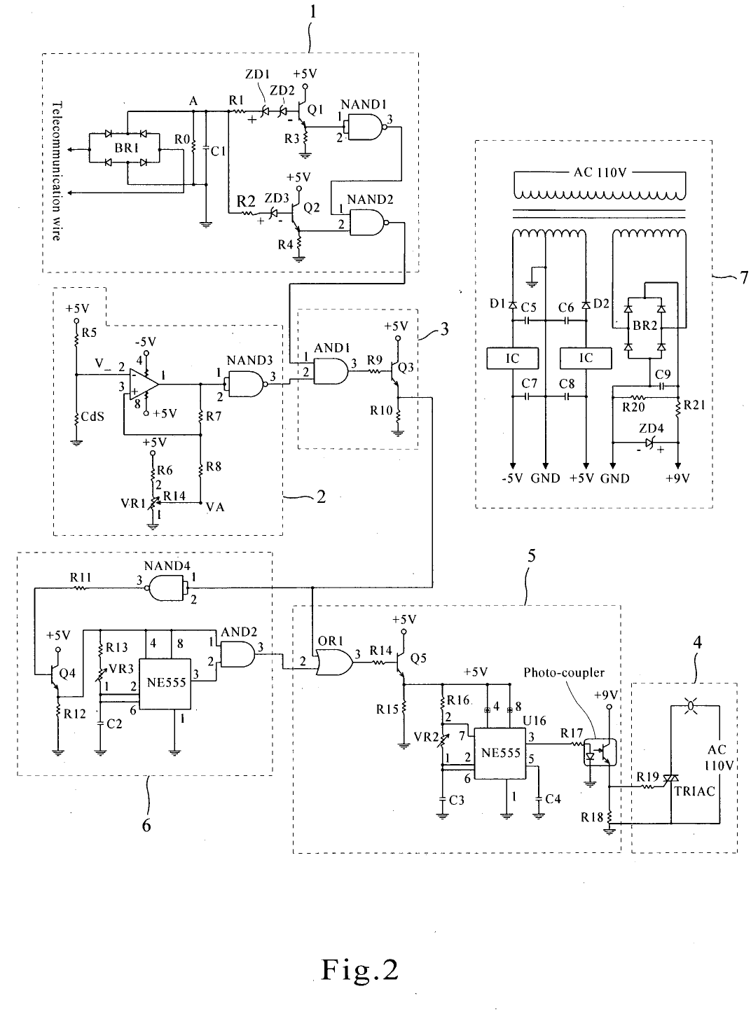

Please continue refer to FIG. 2, which shows a circuit diagram of the nighttime automatic illumination device of the present invention, in accordance with FIG. 1. As shown in FIG. 2, the call detection circuit 1 in the preferred embodiment of the present invention is formed by a bridge rectifier BR1, resistors R0 to R4, a capacitor C1, zener diodes ZD1 to ZD3, transistors Q1 and Q2, and NAND gates NAND1 and NAND2, with the signal input end thereof being connected to the telecommunication signal input end of the telephone detected. As the telephone detected receives the ring signal transmitted via the telecommunication wire, the output end of NAND2 is to output high electric potential signal, which shows that the telephone detected is in current use; contrarily, as the telephone detected is not in current use, the output end of NAND2 is to output a low electric potential signal. The illumination detection circuit 2 in FIG. 2 is formed by resistors R5 to R8, a cadmium sulfide photo-sensitive resistor CdS, an operational amplifier OP1, a variable resistor VR1 and an NAND gate NAND3. As the state of darkness surrounding the telephone detected reaches the predetermined value, the signal output end of NAND3 is to output high electric potential signals to the signal input end of automatic illumination signal circuit 3; if not, the low electric potential signal is to be outputted. The predetermined value of the state of darkness surrounding the telephone can be determined by VR1. Once the state of darkness surrounding the telephone detected reaches the predetermined value, and as the telephone rings or is in current use, the automatic illumination signal circuit 3 formed by an AND gate AND1, a transistor Q3 and resistors R9 and R10 is to receive the high electric potential signal from the call detection circuit 1 and the illumination detection circuit 2, and output the high electric potential signal via the output end of R10, so as to cause the trigger pulse generation circuit 5 to motion, and further activate the driving means for automatic illumination light 4.

The driving means for automatic illumination light 4 in FIG. 2 is formed by a tri-electrode AC switch TRIAC and a resistor R19, and the trigger pulse generation circuit 5 is formed by an OR gate OR1, a transistor Q5, an IC NE555, a photo-coupler, capacitors C3 and C4, resistors R14 to R18 and a variable resistor VR2, so as to provide trigger pulses to the driving means for automatic illumination light 4. In the preferred embodiment of the present invention, as OR1 receives the high-level automatic illumination signal transmitted from the emitter of Q3, the voltage outputted by the emitter of Q5 is near +5V, so as to be the power source for the IC NE555 of the pulse generator, such that, through the modulation caused by VR2, the pulse having frequency of 1200 HZ is generated, which is then transmitted to the photo-coupler to cause the LED to lit the photo-electric transistor, so as to generate trigger pulses at R18. The reason for using the photo-coupler is to prevent harmonic waves generated at the instant of trigger conduction by TRIAC from interfering with the previous electric circuit; thus the lit portion and the lit-reception portion are separated but coupled by the medium of light.

The lights-off delay timer circuit 6 in FIG. 2 is formed by an NAND gate NAND4, an AND gate AND2, a transistor Q4 and an IC NE555, along with resistors R11 to R13, a variable resistor VR3 and a capacitor C2 at the periphery thereof. As the telephoned detected is not in current use with no ring signals, the emitter resistor R10 of Q3 is to output low electric potential signal that is processed to be high electric potential signal via NAND4, so as to conduct to Q4, and provide the power source for the lights-off delay timer circuit 6 having IC NE555 as the core thereof. The lights-off delay time for the timer circuit is determined to be t=1.1×(R13+VR3)×C2 seconds, for example, it can be determined to be 15 seconds through VR3 or other appropriate time. As the lights-off delay timer circuit 6 completes the counting of the predetermined delay time, AND2 is to output low electric potential signals which are then transmitted to OR1, and since another input end of OR1 receives the low electric potential signals inputted from, the emitter of Q3 before the lights-off delay begins to be timed, OR1 is caused to low-level output, such that the power source for the trigger pulse generation circuit 5 in the subsequent circuitry with the function of triggering the driving means for automatic illumination light 4 is cut off, thus TRIAC is to turn off the automatic illumination light for lacking trigger signals.

The power source circuit 7 in FIG. 2 is formed by the power source for the two series of circuits, with one being +9V as the power source for the photo-electric transistor in the photo-coupler, and the other being +5V and −5V as the power source for the whole control circuit.

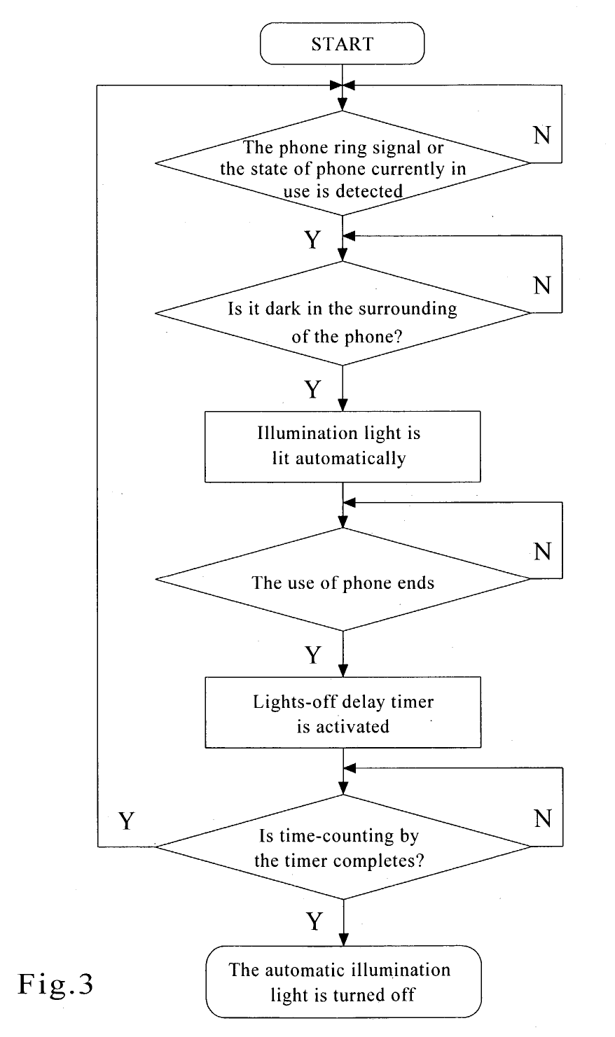

Please refer to FIG. 3, which shows a flow chart of the nighttime automatic illumination device of the present invention, in accordance with FIG. 1 and FIG. 2. As shown in FIG. 3, when the telephone detected receives ring signals transmitted via the telecommunication wire or is in current use, the output end of the call detection circuit 1 is to output high electric potential signals, which shows that the telephone detected is receiving ring signals or in current use; reversely, as the telephone detected is not in current use or not receiving ring signals, the output end of the call detection circuit 1 is to output low electric potential signals and continues to detect signal reception of the telephone.

As the state of darkness surrounding the telephone detected reaches the predetermined value, the signal output end of the illumination detection circuit 2 is to output high electric potential signals; if not, low electric potential signals are outputted, and the illumination detection circuit 2 continues to detect the degree of illumination surrounding the telephone detected. Once the state of darkness surrounding the telephone detected reaches the predetermined value, and the telephone is receiving ring signals or is in current use, the automatic illumination signal circuit 3 is to output high electric potential signals, so as to cause the trigger pulse generation circuit 5 to motion, and further activate the driving means for automatic illumination light 4.

As the telephoned detected is not in current use with no ring signals, the automatic illumination signal circuit 3 is to output low electric potential signals for triggering the lights-off delay timer circuit 6; if not, the driving means for automatic illumination light 4 is continuously activated. As the lights-off delay timer circuit 6 completes the counting of the predetermined delay time, the output of the lights-off delay timer circuit 6 is turned into low electric potential signals and then transmitted to the trigger pulse generation circuit 5. Since another input end of OR1 receives the low electric potential signals inputted from the automatic illumination signal circuit 3 before the lights-off delay begins to be timed, OR1 is caused to low-level output, such that the power source for the trigger pulse generation circuit 5 in the subsequent circuitry with the function of triggering the driving means for automatic illumination light 4 is cut off, thus TRIAC is to turn off the automatic illumination light for no triggering signals can be received and the foregoing telephone detection procedures are resumed.

Although the present invention has been described in considerable detail with reference to certain preferred embodiments thereof, those skilled in the art can easily understand that all kinds of alterations and changes can be made within the spirit and scope of the appended claims. Therefore, the spirit and scope of the appended claims should not be limited to the description of the preferred embodiments contained herein.

What is claimed is:

1. A nighttime automatic illuminating device for telephones comprising:
a call detection circuit for detecting any incoming ring signal inputted via the telecommunication wire of a telephone;
an illumination detection circuit for detecting the degree of illumination surrounding the telephone;
an automatic illumination signal circuit for activating a trigger pulse generation circuit;
a trigger pulse generation circuit for activating a driving means for automatic illumination light;
a driving means for automatic illumination light for driving the illumination of the light according to signals transmitted from said trigger pulse generation circuit;
a lights-off delay timer circuit for cutting off power inputted to said trigger pulse generation circuit; and
a power source circuit for providing with power needed by said circuit members.

2. The nighttime automatic illuminating device for telephones as in claim 1, wherein the signal input end of said automatic illumination signal circuit is connected to the signal output ends of both said call detection circuit and said illumination detection circuit.

3. The nighttime automatic illuminating device for telephones as in claim 1, wherein the signal output end of said automatic illumination signal circuit is connected to the signal input ends of both said lights-off delay timer circuit and said trigger pulse generation circuit.

4. The nighttime automatic illuminating device for telephones as in claim 1, wherein the signal output end of said lights-off delay timer circuit is connected to another signal input end of said trigger pulse generation circuit.

5. The nighttime automatic illuminating device for telephones as in claim 1, wherein said lights-off delay timer circuit further includes a variable resistor for predetermining the cut-off time of the power inputted to said trigger pulse generation circuit.
